(19) United States
(12) Patent Application Publication
(10) Pub. No.: US 2021/0046568 A1
(43) Pub. Date: Feb. 18, 2021

(54) BONDING STRUCTURE OF DISSIMILAR METAL MEMBERS AND PRECURSOR THEREOF

(71) Applicant: HONDA MOTOR CO., LTD., Tokyo (JP)

(72) Inventor: Shohei Kabayama, Wako-shi (JP)

(21) Appl. No.: 16/934,062

(22) Filed: Jul. 21, 2020

(30) Foreign Application Priority Data
Aug. 13, 2019 (JP) 2019-148386
Mar. 10, 2020 (JP) 2020-040739

(51) Int. Cl. B23K 1/19; B23K 1/005; B23K 1/14; B23K 26/082; B23K 26/211; B23K 3/06

(52) U.S. Cl. CPC B23K 1/19; B23K 1/005; B23K 1/14; B23K 26/323; B23K 26/211; B23K 3/063; B23K 26/082

(57) ABSTRACT

A bonding structure of dissimilar metal members, including a first metal member, a second metal member, and a brazing filler metal, wherein the brazing filler metal bonds a bonding end surface of the first metal member and a bonding end surface of the second metal member, and any one or both of the following conditions (1) and (2) are satisfied: (1) at least a part of the bonding end surface of the first metal member in a thickness direction of the first metal member is an inclined surface inclined with respect to a plane perpendicular to the thickness direction of the first metal member, and (2) at least a part of the bonding end surface of the second metal member in a thickness direction of the second metal member is an inclined surface inclined with respect to a plane perpendicular to the thickness direction of the second metal member.

### CROSS-REFERENCE TO RELATED APPLICATION

Priority is claimed on Japanese Patent Application No. 2019-148386, filed Aug. 13, 2019, and Japanese Patent Application No. 2020-θ40739, filed Mar. 10, 2020, the contents of which are incorporated herein by reference.

### BACKGROUND OF THE INVENTION

### Field of the Invention

The present invention relates to a bonding structure of dissimilar metal members and a precursor thereof.

### Description of Related Art

As one of bonding techniques of dissimilar metals having different melting points, brazing is used. Bonding of metals through brazing is performed by heating the members to be bonded by heat from a heat source, supplying a wire-shaped brazing filler metal along a bonding scheduled place (an abutting place) of metal members, and melting the brazing filler metal and then solidifying the brazing filler metal.

As a heat source used in heating of the members to be bonded and melting of the brazing filler metal, a laser beam may be used. However, there is a problem in that brittle intermetallic compounds may be generated depending on combination of dissimilar metals, appropriate heat input control of the bonding members and the brazing filler metals is required in order to suppress brittle intermetallic compounds, and high bonding strength may not be able to be stably obtained.

In order to solve the above-mentioned problems, Japanese Unexamined Patent Application, First Publication No. 2018-114516 discloses a manufacturing apparatus for bonding a first metal member and a second metal member, which are formed of metal materials having different melting points, through brazing, the manufacturing apparatus for dissimilar metal members comprising a laser beam oscillation means for oscillating a laser beam, a laser beam scanning means for scanning an irradiation position of the laser beam oscillated from the laser beam oscillation means, a brazing filler metal supply means for supplying a brazing filler metal along a bonding scheduled line between the first metal member and the second metal member, and a controller configured to control the laser beam scanning means, provided that a melting point of a first metal material that constitutes the first metal member is higher than a melting point of a second metal material that constitutes the second metal member, a direction in which the bonding scheduled line extends is referred to as a first direction, a direction crossing the first direction in a main surface including the bonding scheduled line in the second metal member is referred to as a second direction, and a direction crossing both of the first direction and the second direction is referred to as a third direction, the laser beam is radiated to the irradiation position from one side in the third direction, and the controller causes the laser beam scanning means to scan an irradiation position of the laser beam in a state in which the laser beam scanning means is reciprocated in the second direction while scanning in the first direction and the second direction and a center related to the reciprocation in scanning in the second direction is offset toward the second metal member, and a method of bonding dissimilar metal members using the manufacturing apparatus.

### SUMMARY OF THE INVENTION

In brazing of dissimilar metal members using laser beams, high bonding strength may not be stably obtained.

An aspect of the present invention is directed to providing a bonding structure of dissimilar metal members that stably realizes good bonding strength, and a precursor thereof.

As a result of investigation of the reason why high bonding strength cannot be obtained during laser brazing of dissimilar metal members, the present inventor(s) has found that, when dissimilar metal members are brazed using a laser beam, when the laser beam is radiated on the surfaces of the metal members and surfaces thereof are excessively heated, there is a case in which brittle intermetallic compounds are easily generated and high bonding strength can not be obtained.

Based on this finding, the present inventor(s) has learned that by making a bonding end surface of at least one metal member as an inclined surface, it is possible not to excessively heat surfaces of the metal members and to efficiently heat and melt a brazing filler metal (flux-cored wire), and the generation of intermetallic compounds is minimized, and thereby, good bonding strength is obtained as a result of minimizing generation of intermetallic compounds.

An aspect of the present invention provides the following [1] to [10].

[1] A bonding structure of dissimilar metal members, including: a plate-shaped first metal member, a plate-shaped second metal member formed of a material different from that of the first metal member, and a brazing filler metal, wherein the brazing filler metal bonds a bonding end surface of the first metal member and a bonding end surface of the second metal member, and any one or both of the following conditions (1) and (2) are satisfied:

(1) at least a part of the bonding end surface of the first metal member in a thickness direction of the first metal member is an inclined surface inclined with respect to a plane perpendicular to the thickness direction of the first metal member, and

(2) at least a part of the bonding end surface of the second metal member in a thickness direction of the second metal member is an inclined surface inclined with respect to a plane perpendicular to the thickness direction of the second metal member.

[2] The bonding structure of dissimilar metal members according to [1], wherein the first metal member is an aluminum-based member, the second metal member is an iron-based member, and the brazing filler metal is an aluminum-based brazing filler metal.

[3] The bonding structure of dissimilar metal members according to [2], wherein the second metal member is an iron-based member having a plating layer on a surface thereof.

[4] The bonding structure of dissimilar metal members according to [3], wherein a bonding strength between the aluminum-based member and the iron-based member obtained as a tensile strength is a tensile strength of 50 MPa or more measured according to a tension test method of JIS Z 3192:1999.

[5] The bonding structure of dissimilar metal members according to any one of [2] to [4], wherein at least a part of a bonding end surface of the iron-based member in a thickness direction of the iron-based member is the inclined surface.

[6] The bonding structure of dissimilar metal members according to [5], wherein a magnitude of an angle formed between the inclined surface and the plane perpendicular to the thickness direction of the iron-based member is 30 to 60°.

[7] The bonding structure of dissimilar metal members according to any one of [2] to [6], wherein at least a part of a bonding end surface of the aluminum-based member in a thickness direction of the aluminum-based member is the inclined surface.

[8] The bonding structure of dissimilar metal members according to claim [7], wherein a magnitude of an angle formed between the inclined surface and the plane perpendicular to the thickness direction of the aluminum-based member is 45 to 90°.

[9] A precursor of the bonding structure of dissimilar members according to [5] or [6], the precursor comprising a plate-shaped iron-based member, a plate-shaped aluminum-based member, and a wire-shaped brazing filler metal, wherein the wire-shaped brazing filler metal is disposed to come in contact with the inclined surfaces of the bonding end surface of the iron-based member and the bonding end surface of the aluminum-based member in a lengthwise direction.

[10] The precursor of the bonding structure of dissimilar metal members according to [9], wherein a magnitude of an angle formed between the bonding end surface of the aluminum-based member and a plane perpendicular to a thickness direction of the aluminum-based member is about 90°.

According to the above-mentioned [1], since the brazing filler metal can be efficiently heated without overheating a surface of the metal members, even when combination of the metal members and the brazing filler metal is a combination in which brittle intermetallic compounds are easily generated, and generation of intermetallic compounds due to excessive heat input to the metal member is minimized in the bonding interface between the metal member and the brazing filler metal, it is possible to stably provide a bonding structure of dissimilar metal members in which good bonding strength is provided.

According to the above-mentioned [2], since the aluminum-based member is melted integrally with the aluminum-based brazing filler metal while generation of brittle intermetallic compounds is minimized, it is possible to stably provide a bonding structure between the aluminum-based member and the iron-based member having good bonding strength.

According to the above-mentioned [3], even when the iron-based member is an iron-based member having a plating layer on the surface thereof and brittle intermetallic compounds are easily generated between the iron-based member and the aluminum-based brazing filler metal, since generation of brittle intermetallic compounds is minimized, it is possible to stably provide a bonding structure between the aluminum-based member and the iron-based member having good bonding strength.

According to the above-mentioned [4], since the aluminum-based member is melted integrally with the aluminum-based brazing filler metal while generation of brittle intermetallic compounds is minimized, it is possible to stably provide a bonding structure between the aluminum-based member and the iron-based member having a bonding strength of 50 MPa or more as a tensile strength measured according to the tension test method of JIS Z 3192:1999.

According to the above-mentioned [5], since the aluminum-based brazing filler metal is easily positioned as at least the part of the bonding end surface of the iron-based member in the thickness direction is an inclined surface, as a result of heating the aluminum-based brazing filler metal with the minimum required laser output and brazing filler metal supply quantity without overheating the iron-based member, generation of intermetallic compounds due to excessive heat input to the iron-based member transferred by melting of the aluminum-based member and the brazing filler metal is minimized, and it is possible to stably provide a bonding structure between the aluminum-based member and the iron-based member having good bonding strength.

According to the above-mentioned [6], since the aluminum-based brazing filler metal is more easily positioned as the magnitude of the angle formed between the inclined surface of the iron-based member and the plane perpendicular to the thickness direction is 30 to 60°, as a result of heating the aluminum-based brazing filler metal with the minimum required laser output and brazing filler metal supply quantity, generation of intermetallic compounds due to excessive heat input to the iron-based member transferred by melting of the aluminum-based member and the brazing filler metal is further minimized, and it is possible to stably provide a bonding structure between the aluminum-based member and the iron-based member having better bonding strength.

According to the above-mentioned [7], since the aluminum-based brazing filler metal is easily positioned as at least the part of the bonding end surface of the aluminum-based member in the thickness direction is an inclined surface, as a result of heating the aluminum-based brazing filler metal with the minimum required laser output and brazing filler metal supply quantity, generation of intermetallic compounds due to excessive heat input to the iron-based member transferred by melting of the aluminum-based member and the brazing filler metal is minimized, and it is possible to stably provide a bonding structure between the aluminum-based member and the iron-based member having good bonding strength.

According to the above-mentioned [8], since the aluminum-based brazing filler metal is more easily positioned as the magnitude of the angle formed between the inclined surface of the aluminum-based member and the plane perpendicular to the thickness direction is 45 to 90°, as a result of heating the aluminum-based brazing filler metal with the minimum required laser output and brazing filler metal supply quantity, generation of intermetallic compounds due to excessive heat input to the iron-based member transferred by melting of the aluminum-based member and the brazing filler metal is further minimized, and it is possible to stably provide a bonding structure between the aluminum-based member and the iron-based member having better bonding strength.

According to the above-mentioned [9], since the brazing filler metal can be efficiently heated without overheating the surface of the metal member, even when a combination of the metal member and the brazing filler metal is a combination in which brittle intermetallic compounds are easily generated, as a result of minimizing generation of intermetallic compounds due to excessive heat input to the metal member in the bonding interface between the metal member and the brazing filler metal, it is possible to stably provide the precursor of a bonding structure between the aluminum-based member and the iron-based member having good bonding strength.

According to the above-mentioned [10], from improvement of bonding strength due to melting of the aluminum-based member integrated with the aluminum-based brazing filler metal and easiness of cutting of the aluminum-based member, it is possible to more stably provide the precursor of a bonding structure between the aluminum-based member and the iron-based member having good bonding strength.

### BRIEF DESCRIPTION OF THE DRAWINGS

FIG. 1 is a schematic perspective view showing a schematic configuration of a bonding structure according to a first embodiment of the present invention.

FIG. 2 is a conceptual view showing a schematic diagram of an example of a manufacturing apparatus for manufacturing a bonding structure according to the first embodiment of the present invention.

FIG. 3 is an enlarged schematic perspective view showing a facing portion between a first metal member and a second metal member shown in FIG. 2.

FIG. 4 is a schematic perspective view showing a schematic configuration of a bonding structure according to a second embodiment of the present invention.

FIG. 5 is a conceptual view showing a schematic diagram of an example of a manufacturing apparatus for manufacturing a bonding structure according to the second embodiment of the present invention.

FIG. 6 is an enlarged schematic perspective view of a facing portion between a first metal member and a second metal member shown in FIG. 5.

FIG. 7 is a schematic view showing a specimen of Comparative Example 1.

FIG. 8 is a schematic view showing a specimen of Example 1.

FIG. 9 is a schematic view showing a specimen of Example 2.

FIG. 10 is a schematic view showing a specimen of Example 3.

FIG. 11 is a schematic view showing a specimen of Example 4.

### DETAILED DESCRIPTION OF THE INVENTION

In the specification, a numerical range expressed using “to” includes numerals at both ends of the numerical range.

### First Embodiment

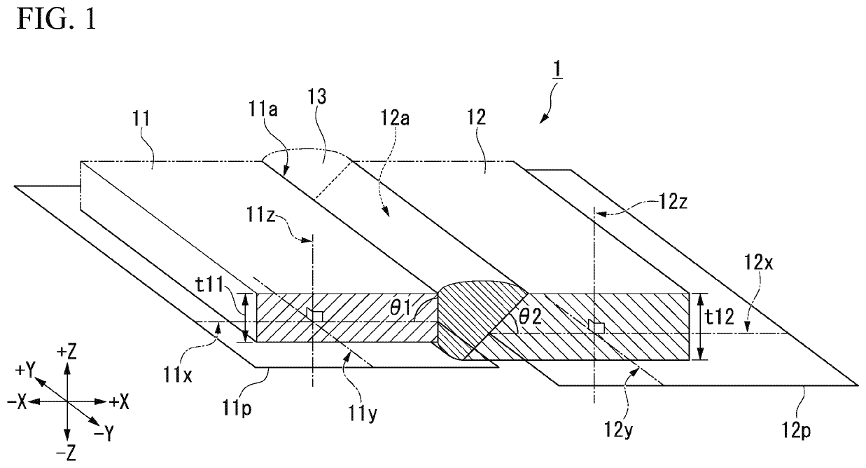

Hereinafter, a first embodiment of the present invention will be appropriately described with reference to FIGS. 1 to 3. Further, the embodiment described below is an aspect of the present invention, the present invention is not limited to the embodiment described below, and various modifications may be made without departing from the scope of the present invention.

### <Bonding Structure>

A bonding structure according to the first embodiment of the present invention will be described with reference to FIG. 1.

A schematic configuration of the bonding structure according to the first embodiment of the present invention is shown in FIG. 1.

A bonding structure 1 shown in FIG. 1 includes a plate-shaped first metal member 11, a plate-shaped second metal member 12, and a brazing filler metal 13.

The second metal member 12 is formed of a material different from the first metal member 11. The brazing filler metal 13 is bonded to a bonding end surface 11 a of the first metal member 11 and a bonding end surface 12a of the second metal member 12.

Further, the bonding structure 1 satisfies any one or both of the following conditions (1) and (2).

(1) The bonding end surface 11a of the first metal member 11 is an inclined surface in which at least a part of the first metal member 11 in a thickness direction is inclined with respect to a plane 11p perpendicular to the thickness direction of the first metal member 11.

(2) The bonding end surface 12a of the second metal member 12 is an inclined surface in which at least a part of the second metal member 12 in a thickness direction is inclined with respect to a plane 12p perpendicular to the thickness direction of the second metal member 12.

### (First Metal Member 11)

The first metal member 11 is, for example, an aluminum-based member, a magnesium-based member, a titanium-based member, or the like, and preferably, an aluminum-based member. While an example of an aluminum-based member may be a member formed of aluminum or an alloy containing aluminum, there is no limitation thereto. In the embodiment, the first metal member 11 is an aluminum alloy plate.

While a size (a thickness t11) of the first metal member 11 in a Z direction is not particularly limited, the size is preferably 0.5 to 2.0 mm, more preferably 0.5 to 1.5 mm, and further preferably 0.8 to 1.2 mm.

Both of sizes of the first metal member 11 in an X direction and a Y direction are not particularly limited, and can be appropriately set according to a use or the like of the bonding structure 1.

The plane 11p is a plane perpendicular to a straight line 11z parallel to the Z direction of the first metal member 11. That is, the straight line 11z is one of normal lines of the plane 11p. Both of a straight line 11x and a straight line 11y are straight lines on the plane 11p and parallel to the X direction and the Y direction of the first metal member 11, respectively. The straight line 11x, the straight line 11y and the straight line 11z are perpendicular to each other at an intersection between the plane 11p and the straight line 11z.

The bonding end surface 11a of the first metal member 11 is disposed at an interface between the first metal member 11 and the brazing filler metal 13.

At least a part of the bonding end surface 11a of the first metal member 11 in the thickness direction of the first metal member 11 is preferably an inclined surface. When at least the part of the bonding end surface 11a of the first metal member 11 in the thickness direction of the first metal member 11 is an inclined surface, since the brazing filler metal can be easily positioned in a precursor of the bonding structure 1, it is easy to heat the brazing filler metal without overheating the first metal member 11 during laser irradiation.

While a magnitude of an angle θ1 formed between the bonding end surface 11a and the plane 11p of the first metal member 11 is not particularly limited, the angle is preferably 30 to 90°, more preferably 45 to 90°, further preferably 60 to 90°, and most preferably 87 to 90° (may be referred to as “about 90°”). When the magnitude of θ1 is within these ranges, since the brazing filler metal can be easily positioned in the precursor of the bonding structure 1, the brazing filler metal is easily heated without overheating the first metal member 11. In FIG. 1, a magnitude of θ1 is 90°. Further, the angle formed between the bonding end surface 11a and the plane 11p of the first metal member 11 may be referred to as an inclination angle of the bonding end surface 11a of the first metal member 11.

In the bonding structure 1 of the embodiment, a bonding interface between the first metal member 11 and the brazing filler metal 13 is not limited to an interface that actually exists, and may be a virtual interface that can be assumed to exist from a state before the first metal member 11 and the second metal member 12 are brazed.

In particular, in the case in which a magnitude of θ1 is about 90°, when the first metal member is an aluminum-based member, the second metal member is an iron-based member, and the brazing filler metal is an aluminum-based brazing filler metal, because of the ease of cutting of the aluminum-based member, the bonding structure 1 can be manufactured more easily. In addition, the aluminum-based member is melted integrally with the aluminum-based brazing filler metal, and the shape of the aluminum-based member conforms to the inclined surface of the iron-based member.

### (Second Metal Member 12)

The second metal member 12 is a metal member different from the first metal member 11, for example, an iron-based member, a magnesium-based member, a titanium-based member, or the like, and preferably an iron-based member. While the example of an iron-based member is a member formed of iron or an alloy containing iron, there is no limitation thereto. Surface treatment such as plating or the like may be performed on the iron-based member. As an iron-based member on which a surface treatment such as plating or the like is performed, in particular, an iron-based member having a plating layer on a surface thereof, for example, a hot-dipped zinc-plated steel plate, an electrolytic zinc-plated steel plate, a hot-dipped aluminum-plated steel plate, and a Galvalume steel plate (registered trademark) are preferable. A zinc-plated steel plate may be further subjected to phosphating or the like. In the embodiment, the second metal member 12 is a hot-dipped aluminum-plated steel plate.

Conventionally, while brittle intermetallic compounds are easily generated on the bonding interface between an aluminum-based brazing filler metal and an iron-based member having a plating layer on the surface thereof, in the present invention, since generation of the brittle intermetallic compounds are minimized, it is possible to provide a bonding structure having good bonding strength.

While a size (a thickness t12) of the second metal member 12 in the Z direction is not particularly limited, the size is preferably 1.0 to 3.0 mm, more preferably 1.0 to 2.5 mm, or further preferably 1.5 to 2.0 mm.

Both of sizes of the second metal member 12 in the X direction and the Y direction are not particularly limited and can be appropriately set according to a use or the like of the bonding structure 1.

The plane 12p is a plane perpendicular to a straight line 12z parallel to the Z direction of the second metal member 12. That is, the straight line 12z is one of normal lines of the plane 12p. Both of a straight line 12x and a straight line 12y are straight lines on the plane 12p and parallel to the X direction and the Y direction of the second metal member 12, respectively. The straight line 12x, the straight line 12y and the straight line 12z are perpendicular to each other at an intersection between the plane 12p and the straight line 12z.

The bonding end surface 12a of the second metal member 12 is disposed at an interface between the second metal member 12 and the brazing filler metal 13.

At least a part of the bonding end surface 12a of the second metal member 12 in the thickness direction of the second metal member 12 is preferably an inclined surface. When at least a part of the bonding end surface 12a of the second metal member 12 in the thickness direction of the second metal member 12 is an inclined surface, since the brazing filler metal is easily positioned in the precursor of the bonding structure 1, it is easy to heat the brazing filler metal without overheating the second metal member 12 during laser irradiation.

While a magnitude of an angle θ2 formed between the bonding end surface 12a and the plane 12p of the second metal member 12 is not particularly limited, the angle is preferably greater than 0° and less than 90°, more preferably 15 to 75°, further preferably 15 to 60°, and most preferably 30 to 60°. When the magnitude of θ2 is within these ranges, since the brazing filler metal is easily positioned in the precursor of the bonding structure 1, it is easy to heat the brazing filler metal without overheating the second metal member 12. In FIG. 1, the magnitude of θ2 is 45°. Further, the angle formed between the bonding end surface 12a and the plane 12p of the second metal member 12 may be referred to as an inclination angle of the bonding end surface 12a of the second metal member 12.

In the bonding structure 1, the bonding interface between the second metal member 12 and the brazing filler metal 13 is not limited to the interface that actually exists, and may be a virtual interface that can be assumed to exist from a state before the first metal member 11 and the second metal member 12 are brazed.

When the first metal member 11 is an aluminum-based member and the second metal member 12 is an iron-based member, it is preferable that at least a part of the bonding end surface 12a of the second metal member 12 in the thickness direction (the Z direction) of the second metal member 12 is an inclined surface, i.e., the magnitude of the angle θ2 formed between the plane 12p and the bonding end surface 12a of the second metal member 12 is less than 90°.

### (Brazing Filler Metal 13)

The brazing filler metal 13 is, for example, an aluminum-based brazing filler metal, a zinc-based brazing material, a gold-based brazing filler metal, a silver-based brazing filler metal, a copper-based brazing filler metal, a nickel-based brazing filler metal, or the like, and preferably, an aluminum-based brazing filler metal. An example of an aluminum-based brazing filler metal is a brazing filler metal formed of an alloy containing aluminum. In the embodiment, the brazing filler metal 13 is an Al—Si-based alloy. The brazing filler metal formed of an aluminum alloy is generally used in brazing of the aluminum-based member. The bonding structure 1 is a bonding structure obtained through laser brazing of the first metal member 11 and the second metal member 12. The bonding end surface 11a of the first metal member 11 and the brazing filler metal 13 are bonded, and the bonding end surface 12a of the second metal member 12 and the brazing filler metal 13 are bonded. In other words, the first metal member 11 and the second metal member 12 are bonded via the brazing filler metal 13.

During manufacture of the bonding structure 1, the brazing filler metal (the flux-cored wire) can be efficiently heated without overheating the surface of the metal member. For this reason, even when a combination of the metal member and the brazing filler metal is a combination in which the brittle intermetallic compounds are easily generated, in the bonding interface between the bonding end surface 11a of the first metal member 11 and the brazing filler metal 13 and the bonding interface between the bonding end surface 12a of the second metal member 12 and the brazing filler metal 13, generation of the intermetallic compounds are minimized As a result, the bonding structure 1 has high tensile strength and good bonding strength.

For example, when the first metal member 11 is an aluminum-based member, the second metal member 12 is an iron-based member, and the brazing filler metal 13 is an aluminum-based alloy, since the first metal member 11 (the aluminum-based member) is melted integrally with the brazing filler metal 13 (the aluminum-based alloy), the first metal member 11 and the brazing filler metal 13 are strongly bonded. The bonding strength of the aluminum-based member and the iron-based member in this case is preferable to be a tensile strength of 50 MPa or more, and ideally, it is desirable that a base metal fracture of the aluminum-based member occurs in a tension test.

Here, the tensile strength of the bonding structure 1 is a tensile strength measured according to a tension test method of JIS Z 3192:1999 “Tension and shearing test method of brazing joints,” and the tensile strength of the aluminum-based member is a tensile strength measured according to JIS Z 2241:2011 “Metal material tension test method.”

### <Method of Manufacturing Bonding Structure 1>

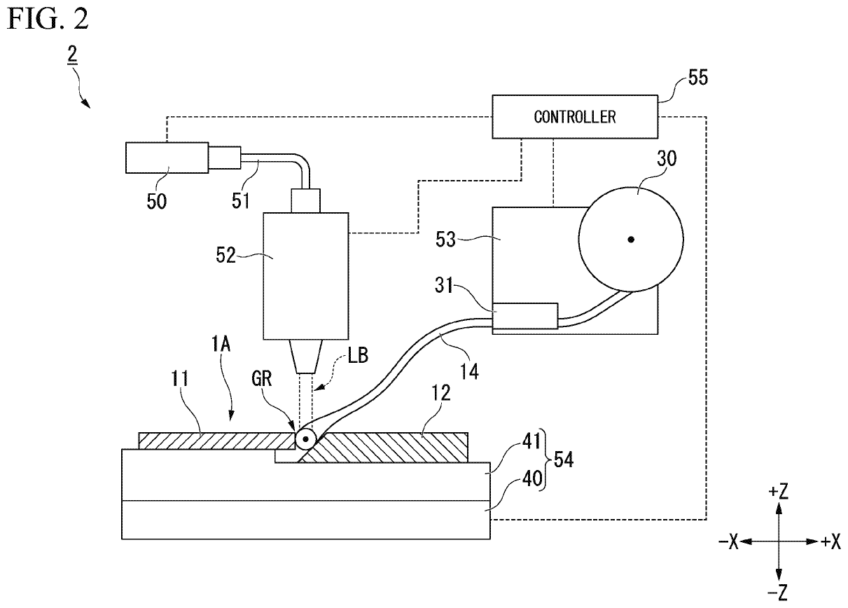

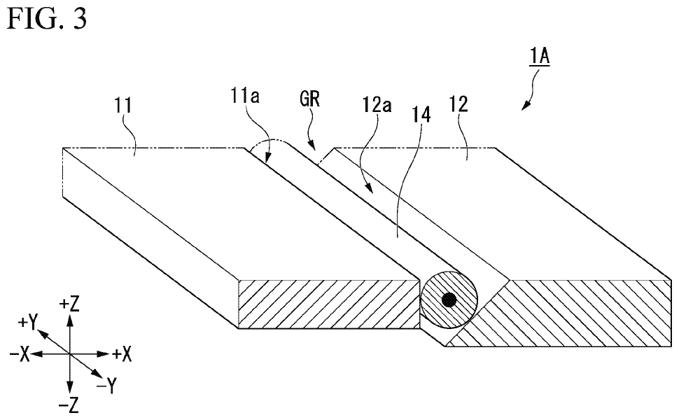

A method of manufacturing a bonding structure according to a first embodiment of the present invention will be described with reference to FIG. 2 and FIG. 3.

FIG. 2 is a conceptual view showing a schematic diagram of an example of a manufacturing apparatus for manufacturing the bonding structure according to the first embodiment of the present invention.

FIG. 3 is an enlarged schematic perspective view of a facing portion between the first metal member and the second metal member shown in FIG. 2.

A manufacturing apparatus 2 shown in FIG. 2 includes a laser beam oscillator 50 that is a laser beam oscillation means, a light guide part 51 configured to guide an oscillated laser beam, a laser beam polarizing part 52 configured to deflect an irradiation position of a laser beam guided by the light guide part 51 in the X direction, a flux-cored wire supply part 53 configured to supply a flux-cored wire 14, a table 54 configured to allow placement of a precursor 1A including the first metal member 11 and the second metal member 12, and a controller 55 configured to perform driving control of the laser beam oscillator 50, the laser beam polarizing part 52, the flux-cored wire supply part 53 and the table 54.

A laser beam LB employed in the manufacturing apparatus 2 is a laser beam selected from a CO₂ laser, a YAG laser, a semiconductor laser, an LD excitation solid laser and a fiber laser.

The light guide part 51 is configured to have, for example, an optical fiber, and guides the laser beam oscillated by the laser beam oscillator 50 to the laser beam polarizing part 52.

The flux-cored wire supply part 53 has a roll part 30 configured to wind the flux-cored wire 14, and a feeder part 31 configured to supply the flux-cored wire 14 to a gap part GR disposed at a facing portion between the first metal member 11 and the second metal member 12. That is, as shown in FIG. 3, the flux-cored wire 14 is supplied to the gap part GR between the first metal member 11 and the second metal member 12, and supported by the bonding end surface 12a of the second metal member 12 and the bonding end surface 11a of the first metal member 11.

The table 54 has a base 40 of which position is fixed, and a movable part 41 that is movable on the base 40 in a direction perpendicular to the drawing. The first metal member 11 and the second metal member 12 are placed on an upper side of the movable part 41 on the +Z side while facing each other. The first metal member 11 and the second metal member 12 are movable in a direction perpendicular to the drawing according to movement of the movable part 41 while the facing state is maintained.

The laser beam LB is emitted from the laser beam polarizing part 52 toward the −Z side, and radiated to the flux-cored wire 14 disposed on the gap part GR.

The flux-cored wire 14 becomes the brazing filler metal 13 as the first metal member 11 and the second metal member 12 are brazed.

The flux-cored wire 14 is constituted by an alloy part formed of an aluminum-based material, and a flux part enclosed by the alloy part. The alloy part is formed of, for example, an Al—Si-based alloy. In addition, the flux part is formed of, for example, a fluorine-based flux including KAlF₄, K₂A1F₅, H₂O, and the like. Since the flux is melted and vaporized, a non-oxidizing atmosphere is maintained by eliminating oxygen while an oxide film on the surface of the metal member is broken.

A diameter of the flux-cored wire 14 is defined on consideration of the size of the gap part GR in the X direction disposed at the facing portion between the first metal member 11 and the second metal member 12, the thickness t11 of the first metal member 11, the thickness t12 of the second metal member 12, the inclination angle of the bonding end surface 11a of the first metal member 11, the inclination angle of the bonding end surface 12a of the second metal member 12, and the like. For example, when the thickness t11 of the first metal member 11 is 1.0 mm, the thickness t12 of the second metal member 12 is 1.8 mm, the inclination angle of the bonding end surface 11a of the first metal member 11 is 90°, and the inclination angle of the bonding end surface 12a of the second metal member 12 is 45°, the diameter of the flux-cored wire 14 is preferably 1.2 mm.

In the gap part GR in which the first metal member 11 and the second metal member 12 face each other, while a small amount of air exists below the flux-cored wire 14, the air can be easily replaced with an inert gas such as nitrogen gas or the like. When the first metal member 11 and the second metal member 12 are brazed using the manufacturing apparatus 2, since the inert gas such as nitrogen gas or the like is blown toward the gap part GR, the air can be replaced with the insert gas and oxidation of the member coupling part can be minimized

In manufacturing the bonding structure of the embodiment using the manufacturing apparatus 2 showing FIG. 2, the first metal member 11 and the second metal member 12 are placed on the table 54, the laser beam LB is radiated to the flux-cored wire 14 disposed on the gap part GR while the flux-cored wire 14 is supplied to the gap part GR, and the first metal member 11 and the second metal member 12 are brazed. A diameter of the laser beam LB is a diameter ±10% of the flux-cored wire 14, preferably a diameter ±5% of the flux-cored wire 14, the laser beam LB is not radiated to the first metal member 11 and the second metal member 12, and the flux-cored wire 14 is sufficiently heated.

Since the flux-cored wire 14 is supported by the first metal member 11 and the second metal member 12 in the gap part GR, the flux-cored wire 14 is easily positioned. Further, the flux-cored wire 14 cannot be easily deviated from the gap part GR. For this reason, the flux-cored wire 14 is efficiently irradiated with the laser beam LB without overheating the surfaces of the first metal member 11 and the second metal member 12 with the laser beam LB.

As a result, generation of the brittle intermetallic compounds in the interface between the metal member and the brazing filler metal is minimized, and the bonding structure having good bonding strength is obtained.

### <Precursor of Bonding Structure 1>

A precursor 1A of the bonding structure 1 of the embodiment is shown FIG. 3. In the precursor 1A shown in FIG. 3, the first metal member 11 and the second metal member 12 are disposed such that the bonding end surface 11a of the first metal member 11 and the bonding end surface 12a of the second metal member 12 face each other, and the flux-cored wire 14 is disposed to come in contact with both of the bonding end surface 11 a of the first metal member 11 and the bonding end surface 12a of the second metal member 12 in the lengthwise direction (the Y direction) of the bonding end surface l la of the first metal member 11 and the bonding end surface 12a of the second metal member 12.

### Second Embodiment

### <Bonding Structure>

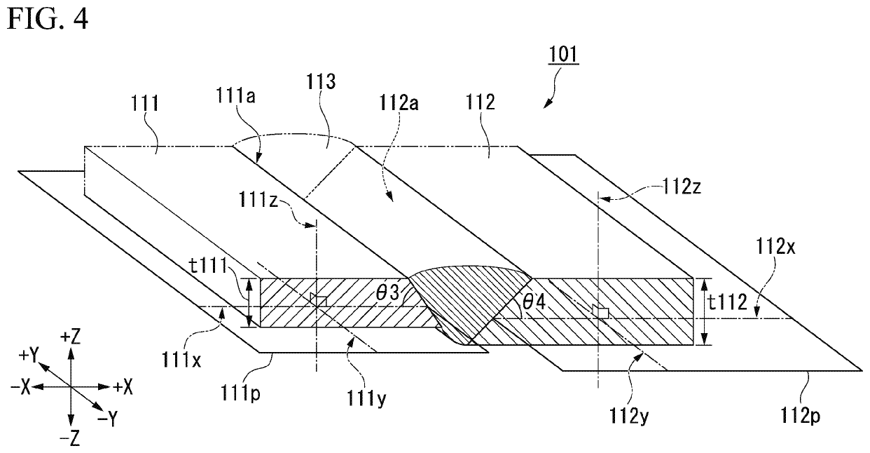

A schematic configuration of a bonding structure according to a second embodiment of the present invention is shown in FIG. 4.

The bonding structure 101 shown in FIG. 4 includes a plate-shaped first metal member 111, a plate-shaped second metal member 112 and a brazing filler metal 113.

The second metal member 112 is formed of a material different from the first metal member 111.

The brazing filler metal 113 is bonded to a bonding end surface 111a of the first metal member 111 and a bonding end surface 112a of the second metal member 112.

Further, the bonding structure 101 satisfies any one or both of the following conditions (1) and (2).

(1) At least a part of the bonding end surface 111a of the first metal member 111 in the thickness direction of the first metal member 111 is an inclined surface inclined with respect to a plane 111p perpendicular to the thickness direction of the first metal member 111.

(2) At least a part of the bonding end surface 112a of the second metal member 112 in a thickness direction of the second metal member 112 is an inclined surface inclined with respect to a plane 112p perpendicular to the thickness direction of the second metal member 112.

### (First Metal Member 111)

The first metal member 111 is, for example, an aluminum-based member, a magnesium-based member, a titanium-based member, or the like, and preferably the aluminum-based member, like the first metal member 11 according to the first embodiment of the present invention. An example of the aluminum-based member is similar to that of the first metal member 11 according to the first embodiment. In the embodiment, the first metal member 111 is an aluminum alloy plate.

While a size (a thickness t111) of the first metal member 111 in the Z direction is not particularly limited like the first metal member 11 according to the first embodiment of the present invention, the thickness is preferably 0.5 to 2.0 mm, more preferably 0.5 to 1.5 mm, and further preferably 0.8 to 1.2 mm.

Both of sizes of the first metal member 111 in the X direction and the Y direction are not particularly limited, and can be appropriately set according to a use of the bonding structure 101.

The plane 111p is a plane perpendicular to a straight line 111z parallel to the Z direction of the first metal member 111. That is, the straight line 111z is one of normal lines of the plane 111p. Both of a straight line 111x and a straight line 111y are straight lines on the plane 111p and parallel to the X direction and the Y direction of the first metal member 111, respectively. The straight line 111x, the straight line 111y and the straight line 111z are perpendicular to each other at an intersection between the plane 111p and the straight line 111z.

The bonding end surface 111a of the first metal member 111 is disposed at an interface between the first metal member 111 and the brazing filler metal 113.

At least a part of the bonding end surface 111a of the first metal member 111 in the thickness direction of the first metal member 111 is preferably an inclined surface. When at least the part of the bonding end surface 111a in the thickness direction of the first metal member 111 is the inclined surface, since the brazing filler metal is easily positioned in the precursor of the bonding structure 101, the brazing filler metal is easily heated without overheating the first metal member 111 during laser irradiation.

While a magnitude of an angle θ3 formed between the bonding end surface 111a and the plane 111p of the first metal member 111 is not particularly limited, the angle is preferably greater than 0° and less than 90°, more preferably 15 to 75°, and further preferably 30 to 60°. In FIG. 4, the magnitude of θ3 is 45°. Further, the angle formed between the bonding end surface 111a and the plane 111p of the first metal member 111 may be an inclination angle of the bonding end surface 111a of the first metal member 111. When the magnitude of θ3 is within the range, since the brazing filler metal is easily positioned in the precursor of the bonding structure 101, the brazing filler metal is easily heated without overheating the first metal member 111.

In the bonding structure 101 of the embodiment, the bonding interface between the first metal member 111 and the brazing filler metal 113 is not particularly limited to an interface that actually exists, and may be a virtual interface that can be assumed to exist from a state before the first metal member 111 and the second metal member 112 are brazed.

### (Second Metal Member 112)

The second metal member 112 is a metal member different from the first metal member 111, and like the second metal member 112 according to the first embodiment of the present invention, for example, an iron-based member, a magnesium-based member, a titanium-based member, or the like, preferably the iron-based member. The example of the iron-based member is the same as the second metal member 112 in the first embodiment. In the embodiment, the second metal member 12 is a zinc-plated steel plate.

While a size (a thickness t112) of the second metal member 112 in the Z direction is not particularly limited like the second metal member 112 according to the first embodiment of the present invention, and the thickness is preferably 1.0 to 3.0 mm, more preferably 1.0 to 2.5 mm, and further preferably 1.5 to 2.0 mm. Both of sizes of the second metal member 112 in the X direction and the Y direction are not particularly limited, the sizes can be appropriately set according to a use or the like of the bonding structure 101.

The plane 112p is a plane perpendicular to a straight line 112z parallel to the Z direction of the second metal member 112. That is, the straight line 112z is one of normal lines of the plane 112p. Both of a straight line 112x and a straight line 112y are straight lines on the plane 112p, and parallel to the X direction and the Y direction of the second metal member 112, respectively. The straight line 112x, the straight line 112y and the straight line 112z are perpendicular to each other at an intersection between the plane 112p and the straight line 112z.

The bonding end surface 112a of the second metal member 112 is disposed at an interface between the second metal member 112 and the brazing filler metal 113.

At least a part of the bonding end surface 112a of the second metal member 112 in the thickness direction of the second metal member 112 is preferably an inclined surface. When at least the part of the bonding end surface 112a of the second metal member 112 in the thickness direction of the second metal member 112 is the inclined surface, since the brazing filler metal is easily positioned in the precursor of the bonding structure 101, the brazing filler metal is easily heated without overheating the second metal member 112 during laser irradiation.

While a magnitude of an angle θ4 formed between the bonding end surface 112a and the plane 112p of the second metal member 112 is not particularly limited, the angle is preferably greater than 0° and less than 90°, more preferably 15 to 75°, further preferably 15 to 60°, and most preferably 30 to 60°. When the magnitude of θ4 is within the range, since the brazing filler metal is easily positioned in the precursor of the bonding structure 101, the brazing filler metal is easily heated without overheating the second metal member 112. In FIG. 4, the magnitude of θ4 is 45°. Further, the angle formed between the bonding end surface 112a and the plane 112p of the second metal member 112 may be an inclination angle of the bonding end surface 112a of the second metal member 112.

In the bonding structure 101 of the embodiment, the bonding interface between the second metal member 112 and the brazing filler metal 113 is not particularly limited to an interface that actually exists, and may be a virtual interface that can be assumed to exist from a state before the first metal member 111 and the second metal member 112 are brazed.

### (Brazing Filler Metal 113)

Like the brazing filler metal 13 according to the first embodiment of the present invention, the brazing filler metal 113 is, for example, an aluminum-based brazing filler metal, a zinc-based brazing material, a gold-based brazing filler metal, a silver-based brazing filler metal, a copper-based brazing filler metal, a nickel-based brazing filler metal, or the like, and preferably the aluminum-based brazing filler metal. An example of the aluminum-based brazing filler metal is the same as that of the brazing filler metal 13 according to the first embodiment. In the embodiment, the brazing filler metal 13 is an Al—Si-based alloy. The brazing filler metal formed of an aluminum alloy is generally used in brazing of the aluminum-based member.

The bonding structure 101 is a bonding structure obtained through laser brazing of the first metal member 111 and the second metal member 112. The bonding end surface 111a of the first metal member 111 and the brazing filler metal 113 are bonded, and the bonding end surface 112a of the second metal member 112 and the brazing filler metal 113 are bonded. In other words, the first metal member 111 and the second metal member 112 are bonded via the brazing filler metal 113.

Like the bonding structure 1 of the first embodiment, the bonding structure 101 of the embodiment has high tensile strength and good bonding strength.

For example, when the first metal member 111 is an aluminum-based member, the second metal member 112 is an iron-based member, and the brazing filler metal 113 is an aluminum-based alloy, since the first metal member 111 (the aluminum-based member) is melted integrally with the brazing filler metal 113 (the aluminum-based alloy), the first metal member 111 and the brazing filler metal 113 are strongly bonded. The bonding strength of the aluminum-based member and the iron-based member in this case is preferable to be a tensile strength of 50 MPa or more, and ideally, it is desirable that a base metal fracture of the aluminum-based member occurs in a tension test. Here, the tensile strength of the bonding structure 1 is tensile strength measured according to a tension test method of JIS Z 3192: 1999 “Tension and shearing test method of brazing joint,” and the tensile strength of the aluminum-based member is tensile strength measured according to JIS Z 2241: 2011 “Metal material tension test method.”

### <Method of Manufacturing Bonding Structure 101>

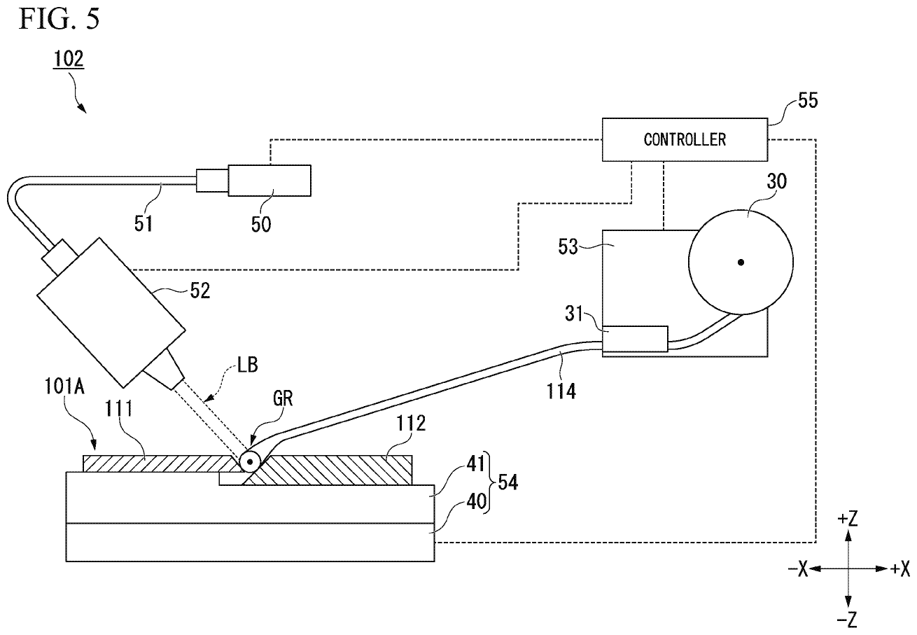

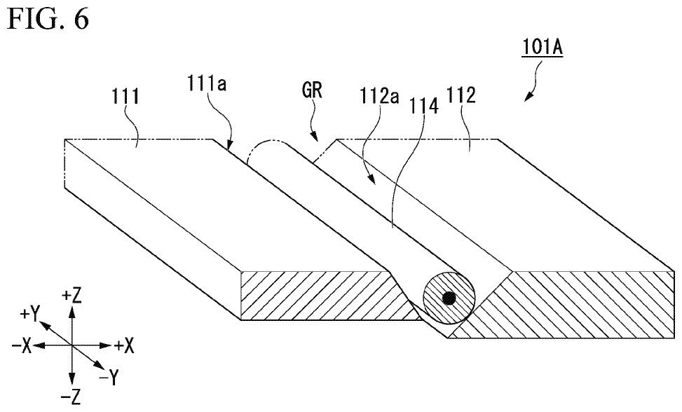

A method of manufacturing a bonding structure according to the second embodiment of the present invention will be described with reference to FIG. 5 and FIG. 6.

FIG. 5 is a conceptual view showing a schematic diagram of an example of a manufacturing apparatus for manufacturing a bonding structure according to the second embodiment of the present invention.

FIG. 6 is an enlarged schematic perspective view showing a facing portion between the first metal member and the second metal member shown in FIG. 5.

A manufacturing apparatus 2A shown in FIG. 5 includes a laser beam oscillator 50 that is a laser beam oscillation means, a light guide part 51 configured to guide an oscillated laser beam, a laser beam polarizing part 52 configured to deflect an irradiation position of the laser beam guided by the light guide part 51 in the X direction, a flux-cored wire supply part 53 configured to supply a flux-cored wire 114, a table 54 configured to place a precursor 101A including the first metal member 111 and the second metal member 112, and a controller 55 configured to perform driving control of the laser beam oscillator 50, the laser beam polarizing part 52, the flux-cored wire supply part 53 and the table 54. While the manufacturing apparatus 2A shown in FIG. 5 has the same configuration as that of the manufacturing apparatus 2 shown in FIG. 2, it is distinguished in that the direction of the laser beam LB is not limited to the −Z direction and the direction of the laser beam LB is changeable.

While radiation of the laser beam LB from above the precursor 101A is common to the method of manufacturing the bonding structure 1 according to the first embodiment, since the direction of the laser beam LB is changed without being limited to the −Z direction, the flux-cored wire 114 disposed in a gap GR between the first metal member 111 and the second metal member 112 can be irradiated with the laser beam LB, and surfaces of the first metal member 111 and the second metal member 112 cannot be irradiated with the laser beam LB.

The laser beam LB employed by the manufacturing apparatus 2 is the same as the laser beam LB employed by the manufacturing apparatus 2A.

The light guide part 51, the laser beam oscillator 50 and the laser beam polarizing part 52 of the manufacturing apparatus 2A have the same configurations as the light guide part 51, the laser beam oscillator 50 and the laser beam polarizing part 52 of the manufacturing apparatus 2, respectively.

The flux-cored wire supply part 53 has the roll part 30 configured to wind the flux-cored wire 114, and the feeder part 31 configured to supply the flux-cored wire 114 to the gap part GR disposed at a facing portion between the first metal member 111 and the second metal member 112.

That is, as shown in FIG. 6, the flux-cored wire 114 is supplied to the gap part GR between the first metal member 111 and the second metal member 112, and supported by the bonding end surface 112a of the second metal member 112 and the bonding end surface 111a of the first metal member 111.

The table 54 has the base 40 of which position is fixed, and the movable part 41 that is movable in a direction perpendicular to the drawing on the base 40. The first metal member 111 and the second metal member 112 are placed on an upper side of the movable part 41 on the +Z side while facing each other. The first metal member 111 and the second metal member 112 are movable in a direction perpendicular to the drawing according to movement of the movable part 41 while the facing state is maintained.

The laser beam LB is emitted from the laser beam polarizing part 52 toward the gap part GR, and radiated to the flux-cored wire 114 disposed at the gap part GR.

The flux-cored wire 114 becomes the brazing filler metal 113 as the first metal member 111 and the second metal member 112 are brazed.

Like the manufacturing apparatus 2 shown in FIG. 2, the flux-cored wire 114 is constituted by an alloy part formed of an aluminum-based material, and a flux part enclosed by the alloy part. The alloy part is formed of, for example, an Al—Si-based alloy. In addition, the flux part is formed of, for example, a fluorine-based flux containing KAlF₄, K₂AlF₅, H₂O, and the like. Since the flux is melted and evaporated, oxygen is eliminated and a non-oxidizing atmosphere is maintained while an oxide film on the surface of the metal member is broken.

The diameter of the flux-cored wire 114 is defined in consideration of the size in the X direction of the gap part GR disposed at the facing portion between the first metal member 111 and the second metal member 112, the thickness t111 of the first metal member 111, the thickness t112 of the second metal member 112, the inclination angle of the bonding end surface 111a of the first metal member 111, the inclination angle of the bonding end surface 112a of the second metal member 112, and the like.

For example, when the thickness t111 of the first metal member 111 is 1.0 mm, the thickness t112 of the second metal member 112 is 1.8 mm, the inclination angle of the bonding end surface 111a of the first metal member 111 is 135°, and the inclination angle of the bonding end surface 112a of the second metal member 112 is 45°, the diameter of the flux-cored wire 114 is preferably 1.2 mm.

While a small amount of air is present below the flux-cored wire 114 in the gap part GR in which the first metal member 111 and the second metal member 112 face each other, the air can be easily replaced with an inert gas such as nitrogen gas or the like. When the first metal member 111 and the second metal member 112 are brazed using the manufacturing apparatus 2, since the inert gas such as nitrogen gas or the like is blown toward the gap part GR, the air can be replaced with the inert gas and the oxygen cannot be affected.

In manufacturing the bonding structure of the embodiment using the manufacturing apparatus 2A shown in FIG. 5, the first metal member 111 and the second metal member 112 are placed on the table 54, the laser beam LB is radiated to the flux-cored wire 114 disposed on the gap part GR while the flux-cored wire 114 is supplied to the gap part GR, and the first metal member 111 and the second metal member 112 are brazed. The diameter of the laser beam LB is a diameter ±10% of the flux-cored wire 114, preferably a diameter ±5% of the flux-cored wire 114, the laser beam LB is not radiated to the first metal member 111 and the second metal member 112, and the flux-cored wire 114 is sufficiently heated.

Since the flux-cored wire 114 is supported by the first metal member 111 and the second metal member 112 in the gap part GR, the flux-cored wire 114 is easily positioned. Further, the flux-cored wire 114 cannot be easily deviated from the gap part GR.

For this reason, the laser beam LB can be efficiently radiated to the flux-cored wire 114 without overheating the surfaces of the first metal member 111 and the second metal member 112 with the laser beam LB.

As a result, generation of the brittle intermetallic compounds in the interface between the metal member and the brazing filler metal is minimized, and the bonding structure having good bonding strength is obtained.

In the manufacturing apparatus 2A shown in FIG. 5, while an irradiation direction of the laser beam LB is changeable without being limited to the −Z direction, it may be possible to incline the table 54 and accurately radiate the laser beam LB to the flux-cored wire 114 supplied to the gap part GR while the irradiation direction of the laser beam LB is fixed to the −Z direction.

### <Precursor of Bonding Structure 101>

The precursor 101A of the bonding structure 101 of the embodiment is shown in FIG. 6.

In the precursor 101A shown in FIG. 6, the first metal member 111 and the second metal member 112 are disposed such that the bonding end surface 111a of the first metal member 111 faces the bonding end surface 112a of the second metal member 112, and the flux-cored wire 114 is disposed to come in contact with both of the bonding end surface 111a of the first metal member 111 and the bonding end surface 112a of the second metal member 112 in the lengthwise direction (the Y direction) of the bonding end surface 111a of the first metal member 111 and the bonding end surface 112a of the second metal member 112.

### EXAMPLE

Hereinafter, while the present invention is more specifically described by the following examples, the present invention is not limited to the following examples and various modifications may be made without departing from the scope of the present invention.

### Comparative Example 1

### (Fabrication of Specimen)

An Al plate 311 (an Al—Mg—Si-based alloy plate, width W1=40 mm, length L1=120 mm, thickness T1=1.0 mm, an angle 90° formed between the bonding end surface and the plane perpendicular to the thickness direction), a Fe plate 312 (a hot-dipped aluminum plated steel plate, width W2=50 mm, length L2=120 mm, thickness T2=1.8 mm, an angle 90° formed between the bonding end surface and the plane perpendicular to the thickness direction) and an aluminum brazing filler metal (a flux-cored wire, an wire outer diameter of 1.6 mm) are prepared.

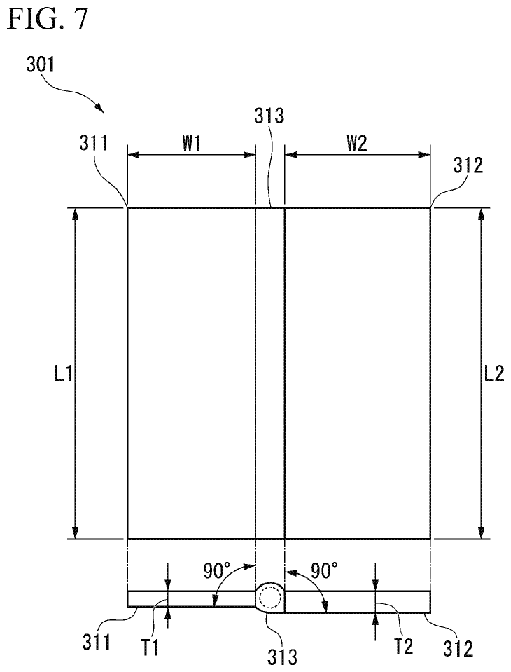

The Al plate 311 and the Fe plate 312 were fixed in a horizontal direction with an aluminum brazing filler metal sandwiched therebetween using the manufacturing apparatus 2 shown in FIG. 2, a laser (a semiconductor (diode) laser, output of 2.1 kW, a spot diameter of Φ1.15 mm) was radiated toward a brazing filler metal from above in a vertical direction, brazing was performed, and thus, a bonding structure 301 shown in FIG. 7 was manufactured. The Al plate 311 and the Fe plate 312 were bonded via an Al brazing filler metal 313. Similarly, a bonding member was additionally fabricated, and three specimens were fabricated in total.

### (Strength Test)

A tension test was performed pursuant to JIS Z 3121: 2013 “Tension test method of butt welded joint” using the bonding structure 301 shown in FIG. 7, and a breaking load, an arithmetical mean (a mean value), and mean tensile strength of each specimen were obtained. Test results are shown in Table 1.

### Example 11

### (Fabrication of Specimen)

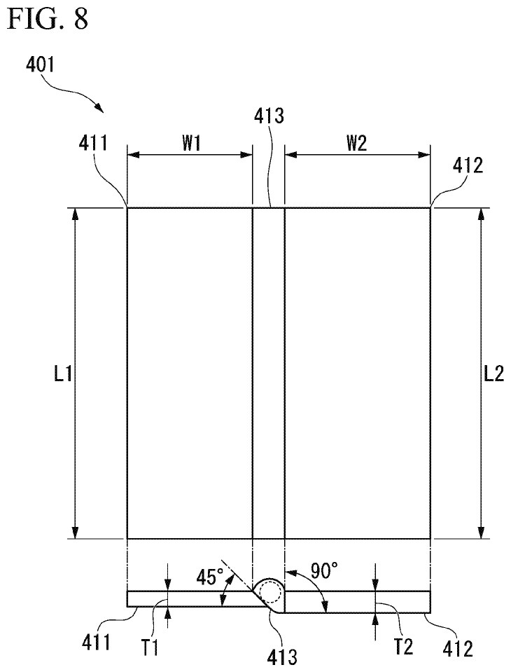

An Al plate 411 (an Al—Mg—Si-based alloy plate, width W1=40 mm, length L1=120 mm, thickness T1=1.0 mm, an angle 45° formed between the bonding end surface and the plane perpendicular to the thickness direction), and a Fe plate 412 (a hot-dipped aluminum plated steel plate, width W2=50 mm, length L2=120 mm, thickness T2=1.8 mm, an angle 90° formed between the bonding end surface and the plane perpendicular to the thickness direction) were prepared. Similar to Comparative Example 1, a bonding structure 401 shown in FIG. 8 was manufactured using them. The Al plate 411 and the Fe plate 412 were bonded via an Al brazing filler metal 413. Similarly, a bonding member was additionally fabricated, and three specimens were fabricated in total.

### (Strength Test)

Similar to Comparative Example 1, a breaking load and an arithmetical mean (mean value), and mean tensile strength of each specimen were obtained using the bonding structure 401 shown in FIG. 8. Test results are shown in Table 1.

### Example 2

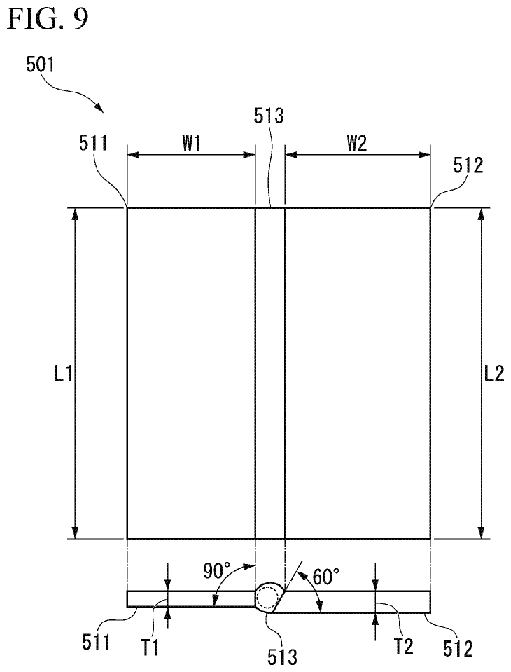

An Al plate 511 (an Al—Mg—Si-based alloy plate, width W1=40 mm, length L1=120 mm, thickness T1=1.0 mm, an angle 90° formed between the bonding end surface and the plane perpendicular to the thickness direction), and a Fe plate 512 (a hot-dipped aluminum plated steel plate, width W2=50 mm, length L2=120 mm, thickness T2=1.8 mm, an angle 60° formed between the bonding end surface and the plane perpendicular to the thickness direction) were prepared. Like Comparative Example 1, a bonding structure 501 shown in FIG. 9 was fabricated using them. The Al plate 511 and the Fe plate 512 were bonded via an Al brazing filler metal 513. Similarly, a bonding member was additionally fabricated, and three specimens were fabricated in total.

### (Strength Test)

Like Comparative Example 1, a breaking load, an arithmetical mean (a mean value), and mean tensile strength of each specimen were obtained using the bonding structure 501 shown in FIG. 9. Test results are shown in Table 1.

### Example 3

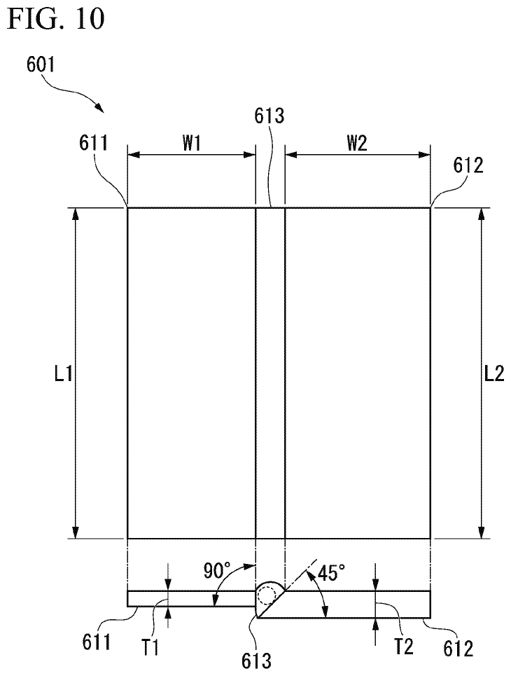

An Al plate 611 (an Al—Mg—Si-based alloy plate, width W1=40 mm, length L1 =120 mm, thickness T1=1.0 mm, an angle 90° formed between the bonding end surface and the plane perpendicular to the thickness direction), and a Fe plate 612 (a hot-dipped aluminum plated steel plate, width W2=50 mm, length L2=120 mm, thickness T2=1.8 mm, an angle 45° formed between the bonding end surface and the plane perpendicular to the thickness direction) were prepared. Like Comparative Example 1, a bonding structure 601 shown in FIG. 10 was manufactured using them. The Al plate 611 and the Fe plate 612 were bonded via an Al brazing filler metal 613. Similarly, a bonding member was additionally fabricated, and three specimens were fabricated in total.

(Strength test)

Like Comparative Example 1, a breaking load, an arithmetical mean (a mean value), and mean tensile strength of each specimen were obtained using the bonding structure 601 shown in FIG. 10. Test results are shown in Table 1.

### Example 4

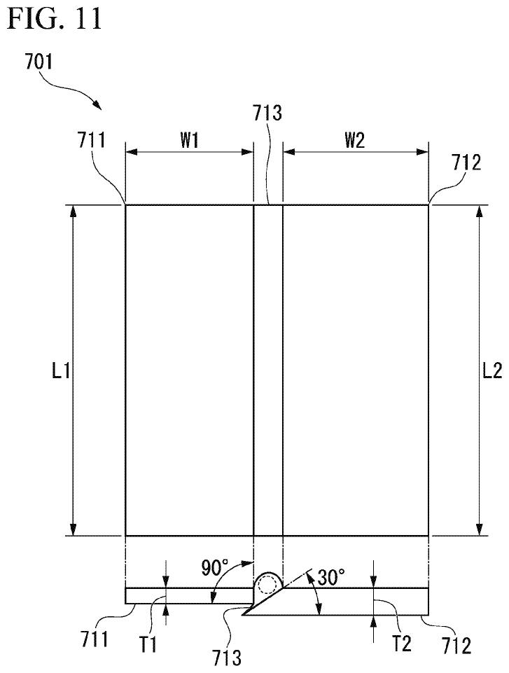

An Al plate 711 (an Al—Mg—Si-based alloy plate, width W1=40 mm, length L1 =120 mm, thickness T1=1.0 mm, an angle 90° formed between the bonding end surface and the plane perpendicular to the thickness direction), and a Fe plate 712 (a hot-dipped aluminum plated steel plate, width W2=50 mm, length L2=120 mm, thickness T2=1.8 mm, an angle 30° formed between the bonding end surface and the plane perpendicular to the thickness direction) were prepared. Like Comparative Example 1, a bonding structure 701 shown in FIG. 11 was fabricated using them. The Al plate 711 and the Fe plate 712 were bonded via an Al brazing filler metal 713. Similarly, a bonding member was additionally fabricated, and three specimens were fabricated in total.

### (Strength Test)

Like Comparative Example 1, a breaking load, an arithmetical mean (a mean value), and mean tensile strength of each specimen were obtained using the bonding structure 701 shown in FIG. 11. Test results are shown in Table 1.

TABLE 1

| | | Comparative | | | | |
|---|---|---|---|---|---|---|
| | | example 1 | Example 1 | Example 2 | Example 3 | Example 4 |
| Angle of bonding | Al plate | 90 | 45 | 90 | 90 | 90 |
| end surface [°] | Fe plate | 90 | 90 | 60 | 45 | 30 |
| Breaking load [N] | Specimen 1 | 4768.80 | 5713.30 | 11944.10 | 12286.85 | 11128.47 |
| | Specimen 2 | 4620.42 | 7443.00 | 12166.08 | 12883.56 | 10725.81 |
| | Specimen 3 | 4975.95 | 6310.81 | 12595.18 | 12349.76 | 8411.53 |
| | Mean value | 4788.39 | 6489.04 | 12055.09 | 12506.72 | 10088.60 |

| | | | | | |
|---|---|---|---|---|---|
| Mean tensile strength [MPa] | 39.90 | 54.08 | 100.46 | 104.22 | 108.48 |

### [Description of Results]

When the angle formed between the bonding end surface of the Al plate or the Fe plate and the plane perpendicular to the thickness direction is less than 90° (Examples 1 to 4), in comparison with the case in which the angle formed between the bonding end surface of the Al plate and the Fe plate and the plane perpendicular to the thickness direction is 90° (Comparative Example 1), the mean value of the breaking load and the mean tensile strength can be increased, and high strength can be realized.

This is considered that heat input can be widely and evenly applied to the bonding surface, generation of the intermetallic compounds are minimized, and the bonding surface with respect to a tensile load applied to the member can be handled in not only the separation direction but also the shearing direction.

In addition, when the plating layer is present on the surface like the zinc-plated steel plate, it is considered to be particularly effective because heat can be input via the plating layer.

The bonding structure of the present invention can be used as a member for an automobile. In particular, it is suitable as a member that requires strength and lightness.

While preferred embodiments of the invention have been described and illustrated above, it should be understood that these are exemplary of the invention and are not to be considered as limiting. Additions, omissions, substitutions, and other modifications can be made without departing from the scope of the present invention. Accordingly, the invention is not to be considered as being limited by the foregoing description, and is only limited by the scope of the appended claims.

What is claimed is:

1. A bonding structure of dissimilar metal members, comprising:
a plate-shaped first metal member, a plate-shaped second metal member formed of a material different from that of the first metal member, and a brazing filler metal,
wherein the brazing filler metal bonds a bonding end surface of the first metal member and a bonding end surface of the second metal member, and
any one or both of the following conditions (1) and (2) are satisfied:
(1) at least a part of the bonding end surface of the first metal member in a thickness direction of the first metal member is an inclined surface inclined with respect to a plane perpendicular to the thickness direction of the first metal member, and
(2) at least a part of the bonding end surface of the second metal member in a thickness direction of the second metal member is an inclined surface inclined with respect to a plane perpendicular to the thickness direction of the second metal member.

2. The bonding structure of dissimilar metal members according to claim 1, wherein the first metal member is an aluminum-based member, the second metal member is an iron-based member, and the brazing filler metal is an aluminum-based brazing filler metal.

3. The bonding structure of dissimilar metal members according to claim 2, wherein the second metal member is an iron-based member having a plating layer on a surface thereof.

4. The bonding structure of dissimilar metal members according to claim 3, wherein a bonding strength between the aluminum-based member and the iron-based member obtained as a tensile strength is a tensile strength of 50 MPa or more measured according to a tension test method of JIS Z 3192:1999.

5. The bonding structure of dissimilar metal members according to claim 3, wherein at least a part of a bonding end surface of the iron-based member in a thickness direction of the iron-based member is the inclined surface.

6. The bonding structure of dissimilar metal members according to claim 5, wherein a magnitude of an angle formed between the inclined surface and the plane perpendicular to the thickness direction of the iron-based member is 30 to 60°.

7. The bonding structure of dissimilar metal members according to claim 2, wherein at least a part of a bonding end surface of the aluminum-based member in a thickness direction of the aluminum-based member is the inclined surface.

8. The bonding structure of dissimilar metal members according to claim 7, wherein a magnitude of an angle formed between the inclined surface and the plane perpendicular to the thickness direction of the aluminum-based member is 45 to 90°.

9. A precursor of the bonding structure of dissimilar members according to claim 5, the precursor comprising a plate-shaped iron-based member, a plate-shaped aluminum-based member, and a wire-shaped brazing filler metal,
wherein the wire-shaped brazing filler metal is disposed to come in contact with the inclined surfaces of the bonding end surface of the iron-based member and the bonding end surface of the aluminum-based member in a lengthwise direction.

10. The precursor of the bonding structure of dissimilar metal members according to claim 9, wherein a magnitude of an angle formed between the bonding end surface of the aluminum-based member and a plane perpendicular to a thickness direction of the aluminum-based member is about 90°.
